(19) United States
(12) Patent Application Publication
(10) Pub. No.: US 2026/0146175 A1
(43) Pub. Date: May 28, 2026

(54) THREE-DIMENSIONAL PRINTING WITH VISIBLE LIGHT ABSORBING DYES

(71) Applicant: PERIDOT PRINT LLC, Palo Alto, CA (US)

(72) Inventors: Emre Hiro Discekici, San Diego, CA (US); Kyler Knowles, Corvallis, OR (US); Sanil Jhaveri, Corvallis, OR (US); Kevin Hulick, Corvallis, OR (US)

(21) Appl. No.: 19/095,564

(22) Filed: Mar. 31, 2025

Related U.S. Application Data
(60) Provisional application No. 63/724,819, filed on Nov. 25, 2024.

(51) Int. Cl. C09D 11/328; B29C 64/124; B29K 77/00; B33Y 70/00; C08K 5/053

(52) U.S. Cl. CPC C09D 11/328; B29C 64/124; B33Y 70/00; C08K 5/053; B29K 2077/00; B29K 2995/002

(57) ABSTRACT

A three-dimensional printing kit includes a fusing agent and a polymeric build material composition. The fusing agent includes a plasticizing solvent package, water, and from about 0.01 wt % active to about 0.35 wt % active of a visible light absorbing dye selected from a yellow dye, a red dye, a blue dye, an orange dye, a green dye, a purple dye, and/or a cyan dye. The plasticizing solvent package consists of i) propylene glycol, or ii) an aromatic alcohol and a plasticizing solvent that increases water solubility of the aromatic alcohol, or iii) propylene glycol, an aromatic alcohol, and a plasticizing solvent that increases water solubility of the aromatic alcohol.

### CROSS-REFERENCE TO RELATED APPLICATION

This application claims the benefit of U.S. Provisional Application Ser. No. 63/724,819, filed Nov. 25, 2024, the content of which is incorporated by reference herein in its entirety.

### BACKGROUND

A three-dimensional (3D) printing process is a form of additive manufacturing that can be used to form 3D solid parts, e.g., using a digital model. Some additive 3D printing techniques involve an iterative application of successive layers of materials, such as build material composition(s), fusing agent(s), and the like. In some of these additive 3D printing techniques, at least partial curing, thermal merging/fusing, melting, sintering, etc. of the build material composition(s) may be used to form the 3D solid parts, and the mechanism for material coalescence may depend upon the type of build material composition(s) used. For some materials, at least partial melting may be accomplished using heat-assisted extrusion. For some other materials, curing or fusing may be accomplished using photonic energy sources, such as ultra-violet light or infrared light sources. 3D printing techniques may be used to generate 3D solid parts with various properties.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of examples of the present disclosure will become apparent by reference to the following detailed description and drawings.

FIG. 1A is a photograph of two objects, both in the shape of a disc, that were 3D printed using a fusing agent including Acid Yellow 23 and Acid Red 52 dyes as visible light absorbers. In the photograph shown in FIG. 1A, each of the objects exhibits a red base color.

FIG. 1B is a photograph of the two objects of FIG. 1A after being dyed with a blue dye. In the photograph shown in FIG. 1B, both of the objects exhibit a dark blue color.

FIG. 2A is a photograph of two objects, both in the shape of a disc, that were 3D printed using a fusing agent including Acid Yellow 23 dye as a visible light absorber. In the photograph shown in FIG. 2A, both of the objects exhibit a yellow base color.

FIG. 2B is a photograph of the two objects of FIG. 2A after being dyed with the same blue dye used to dye the objects of FIG. 1A. In the photograph shown in FIG. 2B, both of the objects exhibit a blue color.

FIG. 3A is a photograph of an object, in the shape of a purse, that was 3D printed using the fusing agent including Acid Yellow 23 and Acid Red 52 dyes as visible light absorbers. In the photograph shown in FIG. 3A, the object exhibits a base color that is orange.

FIG. 3B is a photograph of the object of FIG. 3A after being dyed with a red RIT® dye. In the photograph shown in FIG. 3B, the object exhibits a bright red color.

FIG. 4A is a photograph of another object, also in the shape of a purse, that was 3D printed using a comparative colorless ultraviolet light absorbing fusing agent. In the photograph shown in FIG. 4A, the object exhibits a base color that is off-white.

FIG. 4B is a photograph of the object of FIG. 4A after overcoating with the same red dye used to dye the part of FIG. 3A. In the photograph shown in FIG. 4B, the object exhibited a bright red color similar to, but slighter darker than, the object shown in FIG. 3B.

### DETAILED DESCRIPTION

Some 3D printing methods or techniques utilize an energy absorbing substance (e.g., an energy absorber) to pattern a build material composition, thereby forming a patterned region of the build material composition. In these methods or techniques, an entire layer of the build material composition is exposed to radiation, and the patterned region of the build material composition is coalesced and becomes a layer of a 3D solid part (or 3D printed object). As used herein, the term “coalescence” refers to a process where individual droplets and/or particles of material merge together to form a continuous, solid structure. In this context, coalesced material has merged to form a continuous, solid structure. In the patterned region of build material composition, the energy absorbing substance is capable of at least partially penetrating into voids between the particles of the build material composition and is also capable of spreading onto an exterior surface of particles within the build material composition. The energy absorbing substance is also capable of converting absorbed radiation energy into thermal energy, which may be used to coalesce build material particles that have been patterned with the energy absorbing substance. Coalescing causes the build material particles to join or blend to form a single entity (i.e., a layer of the 3D solid part). Coalescing may involve at least partial thermal merging, melting, binding, and/or some other mechanism that causes the build material composition to form the layer of the 3D solid part.

Some 3D printing methods or techniques utilize a fusing agent that includes the energy absorber to achieve build material coalescence. Such methods or techniques may result in strongly colored 3D solid parts or layer(s) of the 3D solid part, depending at least on the energy absorber used and possibly other components used in the 3D printing method or technique. For example, some 3D printing methods utilize a black-colored energy absorber (e.g., carbon black), which produce black- and/or grey-colored 3D solid parts. The black or grey color may be unsuitable for some 3D solid parts, for example, where the predetermined color of the part is to be white or off-white any color other than black or grey. While alternatives to black-colored energy absorbers have been explored, such alternative energy absorbers (low-tint energy absorbers, such as, e.g., cesium tungsten oxide) tend to lack the same performance capabilities of the black energy absorbers. For instance, difficulties can be encountered when endeavoring to incorporate a low-tint energy absorber into the fusing agent while maintaining the jettability of the fusing agent (e.g., via thermal inkjet applicators) and the ability of the fusing agent to absorb enough radiation to suitably heat and coalesce the build material particles.

Some have proposed the use of ultraviolet (UV) fusing lamps (365 nm) and colorless UV absorbers in an attempt to print durable 3D solid parts that do not exhibit a black or grey color. However, such UV absorbers often present formulation challenges, at least because of their limited solubility in aqueous vehicles, which are particularly suitable for thermal inkjet printed fusing agents. Certain plasmonic resonance absorbers have also been proposed, but these absorbers may introduce issues. For instance, plasmonic resonance absorbers work by manipulating light at specific wavelengths, which can alter the perceived color of a material. This makes it challenging to use these types of absorbers when attempting to achieve accurate and consistent color(s) in the final 3D solid parts. Moreover, plasmonic resonance absorbers can generate significant heat when exposed to light. Significant heat can lead to warped objects or other defects in the printed parts, especially when printing with thermally sensitive materials.

In theory, colorless UV absorbers could be combined with a dye as a colorant in the fusing agent formulation and used for 3D printing of colored parts. However, the high intensity UV light used for fusing the build material particles could bleach the colorant jetted during 3D printing and compromise the color appearance of the 3D printed part. Further, exposure of the polymer build material powder or fused polymer build material to high intensity UV light during fusing cycles may damage the polymer molecular structure and compromise recyclability of the polymer build material, as well as mechanical properties of the 3D printed part. In light of these challenges, 3D printing of high performance (in terms of mechanical properties), colored, polymeric (such as elastomeric) parts is not widespread due to a lack of solutions in the market that offer both high performance and a predetermined cosmetic appearance.

In the examples of the present disclosure described in detail below, 3D printed colored parts having a relatively high L* value can be formed using a layer-by-layer 3D printing process that utilizes a polymeric build material composition and one of the fusing agents disclosed herein. Thus, the initially 3D printed colored part has a light base color that can be readily changed with a post-printing dyeing process. Moreover, the residual plasticizing solvent(s) that is/are present in the initially 3D printed colored part renders the coalesced build material of the part more receptive of the dye used in the post-print dyeing process. The approach disclosed herein enables a wide variation in the final color of the 3D printed part, and improved color fidelity and cosmetic appearance compared to that which is obtainable with other 3D printing solutions, particularly those utilizing a black-colored energy absorber, such as carbon black, or a low-tint energy absorber, such as cesium tungsten oxide.

The examples of the present disclosure also demonstrate a significant departure from 3D printing techniques involving colored paint coatings. Sometimes, parts printed on a Multi Jet Fusion (MJF) printer with elastomeric materials, particularly a thermoplastic polyamide elastomer (TPA) material, meet performance goals but are colored with thick coatings of paint in order to meet aesthetic goals. These coatings can alter the exterior texture of a 3D printed part and/or can chip. The approach described in the present disclosure obviates these issues, as the post-printing dyes chemical bind to or penetrate into the surface of the 3D printed part.

The approach described in the present disclosure also provides an unexpected solution to produce final parts formed by 3D printing that can be dyed to exhibit any one of a wide range of final colors without the need to change the formulation of the build material composition used to form the 3D printed part. For instance, by generating lightly-colored parts, such as yellow or light orange parts, during 3D printing, a significant color range can be achieved using various post-process dyeing techniques. It has unexpectedly been found that the color fidelity of the colored parts produced by the approach described in the present disclosure matches that of white-colored 3D printed parts.

Disclosed herein is a kit for 3D printing that includes a fusing agent and a polymeric build material composition. The kit is used in a 3D printing method that involves generating a 3D printed part exhibiting a primary or secondary color and having a lightness value, L*, that is greater than 40. L* is the lightness value with black at zero (0) and white at one hundred (100). A greater L* value indicates that the 3D printed object has a lighter base color. L* is measured in the CIELAB color space, and may be measured using any suitable color measurement instrument (such as those available from HunterLab or X-Rite). The L* values may be accompanied a* and b* values, where the a* axis is relative to the green-red opponent colors, with negative values toward green and positive values toward red and the b* axis represents the blue-yellow opponents, with negative numbers toward blue and positive toward yellow.

Having an L* value that is greater than 40, the 3D printed part having a light base color can be colored using a post-process dyeing technique to produce a final part having a color that may not be achievable via the 3D printing process alone, due, in part, to constraints with colorant jettability and/or colorant absorption ability. Examples of the fusing agent disclosed herein include a water-soluble dye or mixtures of water-soluble dyes and a plasticizing solvent. The water-soluble dye(s) is/are visible light absorbing dye(s) and is/are used in the fusing agent as the main absorbing functionality (as opposed to black-colored energy absorber(s)). As such, the fusing agent includes the visible light absorbing dye(s) and is free or devoid of carbon black. Moreover, the visible light absorbing dyes have been found to sufficiently coalesce the build material composition when exposed to light, even at relatively low loadings in the fusing agent. The relatively low loadings enable the light color base to be achieved.

As mentioned, the kit for 3D printing, as disclosed herein, comprises a fusing agent and a polymeric build material composition. The fusing agent includes a plasticizing solvent package consisting of i) from about 40 wt % active to about 60 wt % active of propylene glycol, or ii) from about 1 wt % active to about 20 wt % active of an aromatic alcohol and from about 30 wt % active to about 50 wt % active of a plasticizing solvent that increases water solubility of the aromatic alcohol, or from about 10 wt % active to about 30 wt % active of propylene glycol, from about 5 wt % active to about 20 wt % active of an aromatic alcohol, and from about 20 wt % active to about 50 wt % active of a plasticizing solvent that increases water solubility of the aromatic alcohol, with the caveat that a total solvent amount is 75 wt % or less. The fusing agent further includes from about 0.01 wt % active to about 0.35 wt % active of a visible light absorbing dye selected from the group consisting of a yellow dye, a red dye, a blue dye, an orange dye, a green dye, a purple dye, and combinations thereof and a balance of water. The wt % of each component of the fusing agent is based on a total weight of the fusing agent.

Also disclosed herein is a method of using the kit, which includes generating a 3D printed part having an L* greater than 40 and containing multiple fused layers, each of the multiple fused layers being formed by: forming a layer of the polymeric build material composition, based on a 3D object model, selectively applying the fusing agent to the layer; and exposing the layer to light that the dye is capable of absorbing.

Also disclosed herein is a 3D printed part comprising coalesced polymeric build material and a residual amount of a plasticizing solvent package present in the coalesced polymeric build material. The 3D printed part exhibits a primary color or a secondary color having an L* greater than 40.

Throughout this disclosure, a weight percentage that is referred to as “wt % active” refers to the weight percentage of the active component in a formulation. This is calculated by taking the mass of the active component and dividing it by the total mass of the mixture, then multiplying by 100 to get a percentage. Essentially, it represents the concentration of the active ingredient in a formulation, excluding any other non-active components present in the formulation. As an illustration, particles of an energy absorber may be present in a water-based formulation (e.g., a stock solution or dispersion) before being incorporated into a fusing agent. In this example, the wt % active of the energy absorber accounts for the loading (as a weight percent) of the energy absorber solids that are present in the fusing agent and does not account for the weight of the other components (e.g., water, etc.).

Also throughout this disclosure, the terms “3D printing fusing agent,” “3D fusing agent,” and “fusing agent” are used interchangeably herein.

### Kit for 3D Printing

In an example, the kit for 3D printing includes the fusing agent and the polymeric build material composition. In another example, the kit further includes a detailing agent. Details of the fusing agent, the detailing agent, and the polymeric build material composition are set forth below.

It should be understood that the fusing agent and the polymeric build material composition (and the detailing agent, when included) of the kit may be maintained or contained separately until used together in a 3D printing method described in detail below. The fusing agent and/or the polymeric build material composition (and/or the detailing agent) may each be contained in a container prior to and during 3D printing, but may be combined together during 3D printing. The containers can be any type of vessel (e.g., reservoir, box, or receptacle) made of any material.

### Fusing Agent

The fusing agent of the present disclosure includes a plasticizing solvent package, a visible light absorbing dye, and water. In an example, the fusing agent includes the plasticizing solvent package, the visible light absorbing dye, and water, as well as additive(s). In another example, the fusing agent consists of the plasticizing solvent package, the visible light absorbing dye, and water. In still another example, the fusing agent consists of the plasticizing solvent package, the visible light absorbing dye, water, and a surfactant as an additive.

As used herein, the term “plasticizing solvent package” refers to co-solvent(s) other than water that is/are present in the fusing agent, where the “plasticizing solvent package” includes a plasticizing solvent. It should be understood that all of the co-solvents of the plasticizing solvent package are plasticizing solvents. The plasticizing solvents can be combined together to form the plasticizing solvent package prior to being combined or mixed with other component(s) of the fusing agent (e.g., water, dye, etc.). Alternatively, each of the plasticizing solvents could be incorporated into the fusing agent separately. The term “plasticizing solvent” refers to a low-volatility solvent that interacts with and increases the flexibility (i.e., plasticizes) of the build material polymer. This may generate a more pliable surface that improves dye penetration. The plasticizing solvent(s) also facilitates a melt temperature reduction of the build material polymer. This enables a lower concentration of the dye to be used without compromising the fusing efficiency. With less dye, less color is imparted to the initial 3D printed object, making it more suitable for post-process dyeing.

It is to be understood that throughout this disclosure, the terms “solvent” and “co-solvent” are used interchangeably. Some examples of the co-solvent disclosed herein increase the solubility of a compound in the fusing agent.

In one example, the plasticizing solvent package consists of propylene glycol (PG or 1,2-propanediol). In this example, the plasticizing solvent package consists of a single plasticizing solvent (i.e., propylene glycol) and is free or devoid of any other solvents, including any other additional plasticizing solvent. The propylene glycol is present in the fusing agent in an amount ranging from about 40 wt % active to about 60 wt % active, based on the total weight of the fusing agent. In another example, the propylene glycol is present in the fusing agent in an amount ranging from about 45 wt % active to about 55 wt % active, based on the total weight of the fusing agent. In still another example, the propylene glycol is present in the fusing agent in an amount ranging from about 48 wt % active to about 52 wt % active, based on the total weight of the fusing agent. In a particular example, the propylene glycol is present in the fusing agent in an amount of about 50 wt % active.

In an alternative example, the plasticizing solvent package consists of an aromatic alcohol and a plasticizing solvent that increases the water solubility of the aromatic alcohol. In an example, the aromatic alcohol is benzyl alcohol, which has the formula C₆H₅CH₂OH. Another aromatic alcohol that could be used is 2-phenoxyethanol. The aromatic alcohol is present in the fusing agent in an amount ranging from about 1 wt % active to about 20 wt % active, based on the total weight of the fusing agent. In another example, the aromatic alcohol is present in the fusing agent in an amount ranging from about 5 wt % active to about 15 wt % active, based on the total weight of the fusing agent. In still another example, the aromatic alcohol is present in the fusing agent in an amount ranging from about 8 wt % active to about 12 wt % active, based on the total weight of the fusing agent. It is noted that at concentrations higher than 20 wt % active, the aromatic alcohol could adversely affect print reliability.

The plasticizing solvent in this example is any plasticizing solvent that is a solvent for the aromatic alcohol, and thus will suitably increase the water solubility of the aromatic alcohol. The solvent that is selected may have a higher solubility for the aromatic alcohol than water. In other words, the plasticizing solvent assists in bringing the aromatic alcohol into solution. The inclusion of such a solvent enables the fusing agent to be prepared with a predetermined amount of aromatic alcohol that is suitable for solubilizing and plasticizing the build material during 3D printing.

Plasticizing solvents that are solvents for some aromatic alcohols, such as benzyl alcohol, include water-soluble or water-miscible co-solvents, such as 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, other glycol ethers, poly(ethylene glycol) 300, and combinations thereof. In an example, the plasticizing solvent is selected from the group consisting of 1-(2-hydroxyethyl)-2-pyrrolidone (HE2P), glycerol, isopropylidene glycerol (IPG), polyethylene glycol (PEG) 300, and combinations thereof. In a particular example, the plasticizing solvent is 1-(2-hydroxyethyl)-2-pyrrolidone.

The amount of solvent for the aromatic alcohol that is included may depend, in part, upon the amount of aromatic alcohol that is included in the fusing agent. In an example, the benzyl alcohol and the solvent are present (in the fusing agent) in a weight ratio ranging from about 1:50 to about 2:3. In an example, the benzyl alcohol and the solvent are present in a weight ratio of 1:3.

The plasticizing solvent for the aromatic alcohol (e.g., benzyl alcohol) in the current example of the plasticizing solvent package may be present in the fusing agent in an amount ranging from about 30 wt % active to about 50 wt % active, based on the total weight of the fusing agent. In another example, the plasticizing solvent in the current example of the plasticizing solvent package is present in the fusing agent in an amount ranging from about 40 wt % active to about 50 wt % active, based on the total weight of the fusing agent.

In one specific example, the solvent package consists of the aromatic alcohol and the plasticizing solvent; the aromatic alcohol is benzyl alcohol; and the plasticizing solvent is selected from the group consisting of 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, poly(ethylene glycol) 300, and combinations thereof.

In another alternative example, the plasticizing solvent package consists of propylene glycol, an aromatic alcohol, and a plasticizing solvent. Aromatic alcohols and plasticizing solvents that may suitably be used for this example of the plasticizing solvent package are the same as described in the alternate example of the solvent package above. In one specific example, the solvent package consists of propylene glycol, the aromatic alcohol, and the plasticizing solvent; the aromatic alcohol is benzyl alcohol; and the plasticizing solvent is selected from the group consisting of 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, poly(ethylene glycol) 300, and combinations thereof.

In this example of the plasticizing solvent package, the propylene glycol is present in an amount ranging from about 10 wt % active to about 30 wt % active, or from about 15 wt % active to about 25 wt % active, or from about 18 wt % active to about 22 wt % active, based on the total weight of the fusing agent. The aromatic alcohol is present in the fusing agent in an amount ranging from about 5 wt % active to about 20 wt % active, or from about 10 wt % active to about 20 wt % active, or even from about 12 wt % active to about 16 wt % active, based on the total weight of the fusing agent. Again, at concentrations greater than 20 wt % active, the aromatic alcohol could adversely affect print reliability. The plasticizing solvent is present in the fusing agent in an amount ranging from about 20 wt % active to about 50 wt % active, or from about 40 wt % active to about 50 wt % active based on the total weight of the fusing agent. In this example of the plasticizing solvent package, the total amount of the solvents is 75 wt % active or less. In other words, the combined total of the propylene glycol, the aromatic alcohol, and the plasticizing solvent ranges from about 35 wt % active to about 75 wt % active. As one example, if the plasticizing solvent is to be included at 50 wt % active, then the total amount of propylene glycol plus the aromatic alcohol should be 25 wt % or less.

The fusing agent further comprises the visible light absorbing dye. In some examples, a single visible light absorbing dye is included in the fusing agent. In other examples, more than one visible light absorbing dye, e.g., a combination of dyes, is included in the fusing agent. The dye or combination of dyes present in the fusing agent is capable of absorbing electromagnetic energy at certain wavelengths, and so the dye or combination of dyes functions as an energy absorber in the fusing agent. Suitable visible light absorbing dyes include any organic or inorganic dye that is capable of absorbing light within the visible spectrum. In an example, the dye or dyes have substantial absorption at wavelengths ranging from about from about 380 nm to about 700 nm. In another example, the dye or dyes have substantial absorption at wavelengths ranging from about 400 nm to about 590 nm. As used herein, the term “substantial absorption” means that at least 80% of radiation having wavelengths within the specified range is absorbed by the substance being referred to. The dye or combination of dyes is capable of absorbing and converting absorbed radiation into a sufficient amount of thermal energy to coalesce build material particles that have been patterned with the fusing agent (as will be described in more detail with reference to a 3D printing method below).

The visible light absorbing dye may be selected from the group consisting of a yellow dye, a red dye, a blue dye, an orange dye, a green dye, a purple dye, and combinations thereof. Examples of yellow dyes that may suitably be used as the visible light absorbing dye include Acid Yellow (AY) dyes, such as AY-17, AY-23, AY-24, and AY-73. Examples of red dyes that may suitably be used as the visible light absorbing dye include Acid Red (AR) dyes, such as AR-1, AR-27, AR-52, AR-88, and AR 289, as well as Reactive Red (RR) dyes, such as RR-180. Examples of blue dyes that may suitably be used as the visible light absorbing dye includes Acid Blue (AB) dyes, such as AB-9, Direct Blue (DB) dyes, such as DB-199, and anthraquinones dissolved in a suitable solvent. It is believed that any acid dye of the suitable color (e.g., orange, green etc.) may be used in the fusing agent set forth herein. While a few examples of the various dyes have been listed, it should be understood that there are many other dyes that can absorb light in the visible spectrum that may be included in the fusing agent. Any of the secondary colors may be obtained using a dye of that color (e.g., Acid Orange 7) or by mixing primary colored dyes together.

In certain examples, the fusing agent includes a yellow dye alone, a red dye alone, an orange dye alone, a combination of a red dye and a yellow dye, a combination of a red dye and a blue dye, or a combination of a yellow dye and a blue dye.

In one example, the visible light absorbing dye is a combination of the yellow dye (e.g., AY-23) and the red dye (e.g., AR-52), where the yellow dye is present in an amount ranging from about 0.1 wt % active to about 0.3 wt % active and the red dye is present in an amount ranging from about 0.01 wt % active to about 0.05 wt % active, both based on the total weight of the fusing agent. With this combination and loading of dyes in the fusing agent, the 3D printed part can exhibit a base color that is light orange.

In another example, the visible light absorbing dye is a combination of the red dye (e.g., AR-52) and the blue dye (e.g., Acid Blue dyes), where the red dye is present in an amount ranging from about 0.1 wt % active to about 0.3 wt % active and the blue dye is present in an amount ranging from about 0.01 wt % active to about 0.05 wt % active, both based on the total weight of the fusing agent. With this combination and loading of dyes in the fusing agent, the 3D printed part can exhibit a base color that is purple.

In yet another example, the visible light absorbing dye is a combination of a yellow dye (e.g., AY-23) and a blue dye (e.g., Acid Blue dyes), where the yellow dye is present in an amount ranging from about 0.1 wt % active to about 0.3 wt % and the blue dye is present in an amount ranging from about 0.01 wt % active to about 0.05 wt % active, both based on the total weight of the fusing agent. With this combination and loading of dyes in the fusing agent, the 3D printed part can exhibit a base color that is light green.

It should be understood that there are many different combinations of two dyes can be used to produce a light base color of the 3D printed object. For instance, a 3D printed object formed using a combination of a blue dye and an orange dye can exhibit a brownish color, a 3D printed object formed using a combination of a green dye and a cyan dye can exhibit a teal color, a 3D object formed using a combination of a yellow dye and a green dye can exhibit a chartreuse color, and so on. With the dye loadings being so low per the ranges set forth herein, the resulting 3D printed object will have a light color, with an L* greater than 40. The selection of the base color aids in achieving the final color post dyeing. While the examples described above include a combination of two dyes, it should be understood that combinations of three or more dyes can also be used. Additionally, combinations of two or more dyes of the same color (e.g., two different yellow dyes) are also envisioned.

In an example, the total amount of visible light absorbing dye(s) present in the fusing agent ranges from about 0.01 wt % active to about 0.35 wt % active, based on the total weight of the fusing agent. In another example, the total amount of visible light absorbing dye(s) present in the fusing agent ranges from about 0.1 wt % active to about 0.25 wt % active, based on the total weight of the fusing agent. The relatively low amount of dye(s) present in the fusing agent is due, at least in part, to the presence of the plasticizing solvent package described above.

In addition to the plasticizing solvent package described herein, the fusing agent also includes water and, in some instances, additive(s). These liquid components make up a liquid vehicle of the fusing agent. Examples of the additives include surfactants, antimicrobial agents, chelating agents, anti-kogation agents, buffers, and combinations thereof. In an example, the fusing agent consists of the plasticizing solvent package, water, and the dye(s). In another example, the fusing agent consists of the plasticizing solvent package, water, the dye(s), and a surfactant.

The fusing agent may further include a surfactant as the additive. Examples of surfactants that may be used for the fusing agent include non-ionic or anionic surfactants. Some example surfactants include alkyl polyethylene oxides, alkyl phenyl polyethylene oxides, polyethylene oxide block copolymers, acetylenic polyethylene oxides, polyethylene oxide (di) esters, polyethylene oxide amines, dimethicone copolyols, substituted amine oxides, fluorosurfactants, and the like. Some examples of these surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another anionic surfactant includes alkyldiphenyloxide disulfonate (e.g., the DOWFAX™ series, such a 2A1, 3B2, 8390, C6L, C10L, and 30599, from The Dow Chemical Company). Whether a single surfactant is used, or a combination of surfactants is used, the total amount of surfactant(s) ranges from about 0.01 wt % active to about 2 wt % active, based on the total weight of the fusing agent. In another example, the total amount of surfactant(s) used is about 0.8 wt % active, based on the total weight of the fusing agent.

Antimicrobial agents are also known as biocides and/or fungicides. Examples of suitable antimicrobial agents that may be used as an additive in the fusing agent include NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant Int. Ltd.), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) ranges from about 0.01 wt % active to about 0.05 wt % active, based on the total weight of the fusing agent.

Chelating agents (or sequestering agents) may be included in the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) may range from greater than 0 wt % active to about 0.5 wt % active, based on the total weight of the fusing agent.

In some examples, the additive in the fusing agent is an anti-kogation agent. “Kogation” refers to the deposit of dried printing liquid (e.g., the fusing agent) on a heating element of a thermal inkjet printhead. Anti-kogation agent(s) is/are included to assist in preventing the buildup of kogation. Examples of anti-kogation agents include oleth-3-phosphate (commercially available as CRODAFOS™ O3A or CRODAFOS™ N-3A) or dextran 500,000. Other examples of the anti-kogation agents include CRODAFOS™ HCE (a phosphate-ester from Croda Int.), CRODAFOS® 010A (oleth-10-phosphate from Croda Int.), and DISPERSOGEN® LFH (a polymeric dispersing agent with aromatic anchoring groups, acid form, anionic, from Clariant Int. Ltd.), etc. It is to be understood that any combination of the anti-kogation agents listed may be used.

In an example, the total amount of anti-kogation agent(s) may range from greater than 0 wt % active to about 0.5 wt % active, based on the total weight of the fusing agent.

The liquid vehicle may also include a buffer. Examples of suitable buffers include tris(Hydroxymethyl)aminomethane based buffers, such as TRIS and TRIZMA, and (4-(2-hydroxyethyl)-1-piperazineethanesulfonic acid) (HEPES).

In an example, the total amount of buffer(s) may range from 0.01 wt % active to about 1 wt % active, based on the total weight of the fusing agent.

In addition to the plasticizing solvent package, the liquid vehicle of the fusing agent further includes water. The water generally makes up a balance of the fusing agent, relative to the other components included in the fusing agent (e.g., the plasticizing solvent package, visible light absorbing dye(s), and any additives included in the fusing agent). The amount of water included in the fusing agent depends upon the amount of each of the other components included in the fusing agent. In an example, the amount of water present in the fusing agent ranges from 10 wt % to about 70 wt %, based on the total weight of the fusing agent. In another example, the amount of water preset in the fusing agent ranges from 25 wt % to 70 wt %, based on the total weight of the fusing agent. The water may be pure water, deionized water (DI water), distilled water, or any other suitable form of water.

Table 1 below illustrates an example formulation of the fusing agent that may be used:

TABLE 1

| Component | % active | Wt % |
|---|---|---|
| Plasticizing solvent(s) | 100 | 30-50 |
| Yellow Dye | 10 | 1-3 |
| Red Dye | 10 | 0.1-0.5 |
| Aromatic alcohol | 100 | 1-20 |
| Surfactant | 100 | 0.05-1 |
| Water | 100 | Balance |

The example of the fusing agent set forth in Table 1 may be used in a 3D printing method with or without a detailing agent and with the build material composition, both of which are described further below.

### Detailing Agent

The detailing agent may include a surfactant, a co-solvent, and a balance of water. In an example, the detailing agent consists of these components and no other components. In another example, the detailing agent further includes additional components, such as anti-kogation agent(s), antimicrobial agent(s), and/or chelating agent(s), each of which is described above in reference to the fusing agent. Any of the examples of the additives (surfactant(s), anti-kogation agent(s), etc.) may be included in the detailing agent in the amounts set forth herein for the fusing agent. The balance of the detailing agent is water. As such, the amount of water may vary depending upon the amounts of the other components that are included in the detailing agent.

The detailing agent may also include co-solvent(s). Classes of water soluble or water miscible organic co-solvents that may be used in the detailing agent include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, other diols (e.g., 2-methyl-1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, 1-methyl-2-pyrrolidone, 2-pyrrolidone, and the like. Other examples of suitable organic co-solvents include dimethyl sulfoxide (DMSO), isopropyl alcohol, ethanol, pentanol, acetone, or the like.

The examples of the detailing agent disclosed herein do not include a colorant. As such, the detailing agent is colorless. As used herein, “colorless” means that the detailing agent is achromatic and does not include a colorant. The colorless detailing agent, in combination with the fusing agent, may be used to generate 3D object layer(s)/object(s) exhibiting a base color.

### Build Material Composition

The fusing agent of the present disclosure may be suitable for printing on a polymeric build material composition (referred to interchangeably herein as the “build material composition”). Some examples of suitable polymeric materials for the polymeric build material composition include polyamides, polyacetals, polyolefins, styrene copolymers, acrylic polymers and copolymers, polyethers, polyaryletherketones, polyesters (e.g., a thermoplastic copolyester (TPC)), polycarbonates (PC), a thermoplastic polyurethane elastomer (TPU), a thermoplastic polyolefin elastomer (TPO), a polyether block amide (PEBA), or a combination thereof. In an example, the polymer material is selected from the group consisting of polyethylene, polyethylene terephthalate (PET), polypropylene, high density polyethylene (HDPE), polyoxymethylene (POM), polyether ketone (PEK), polyether ether ketone (PEEK), polyetherketoneketone (PEKK), polyphenylene sulfide (PPS), acrylonitrile styrene acrylate (ASA), poly(methyl methacrylate) (PMMA), styrene acrylonitrile (SAN), styrene maleic anhydride (SMA), poly(vinyl chloride) (PVC), polyethylenimine (PEI), and combinations thereof. In some instances, the polymeric material may be referred to herein as an elastomer.

In some examples, the polymeric build material composition is a polyamide build material composition including polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. The term “average particle size,” as used herein, refers to a volume-weighted mean diameter of a particle distribution.

In some examples, in addition to the polymeric material, the build material composition may include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material.

In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to bring the L* of the build material composition closer to 100 (white) and/or improve visibility. It is to be understood, however, that some examples of the build material composition do not include the whitener. Examples of suitable whiteners include titanium dioxide (TiO₂), zinc oxide (ZnO), calcium carbonate (CaCO₃), zirconium dioxide (ZrO₂), aluminum oxide (Al2O₃), silicon dioxide (SiO₂), boron nitride (BN), barium sulfate, and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative).

Any example of the whitener may be included in the build material composition in an amount ranging from greater than 0 wt % to about 10 wt %, based on the total weight of the build material composition.

Antistatic agent(s) may be added to the polymeric build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.).

In an example, the antistatic agent is added in an amount ranging from greater than 0 wt % to less than 5 wt %, based upon the total weight of the build material composition.

Flow aid(s) may be added to improve the coating flowability of the polymeric build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al2O₃), tricalcium phosphate (E341), powdered cellulose (E460 (ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900).

In an example, the flow aid is added in an amount ranging from greater than 0 wt % to less than 5 wt %, based upon the total weight of the build material composition.

### Dye Solution

In an example, the kit further includes a dye solution that may be used for post-process dyeing of the 3D printed object. The dye solution is separate from the fusing agent and includes a dye (which may be referred to herein as a second dye). The dye for the dye solution can be any dye, such as acid dyes, disperse dyes, and/or direct dyes. The second dye can be a red dye, a pink dye, an orange dye, a blue dye, a green dye, and combinations thereof. The dye solution may consist of a liquid dye, and thus may include no other components. Alternatively, the dye solution may include the liquid dye, sodium chloride, and an anionic and/or non-ionic surfactant. Examples of these dye solutions include RIT® Dyes (available from Nakoma Products, LLC). In still other examples, the dye solution may include a powdered dye that has been combined with water to form an aqueous dye solution. The amount of dye and the amount of water in the aqueous dye solution depends on the intensity of the color to be achieved. For instance, a lower color intensity would require a lower amount of dye in the aqueous dye solution, while a higher color intensity would require a higher amount of dye in the aqueous dye solution.

### 3D Printing Method

An example of a 3D printing method utilizing the fusing agent is described in detail below. Prior to execution of the method, it is to be understood that a controller may access data stored in a data store pertaining to a 3D solid part (or 3D printed object) that is to be made/printed. For example, the controller may determine the number of layers of a build material composition that are to be formed, the locations at which the fusing agent (and detailing agent, if used) is to be deposited on each of the respective layers, etc.

The method includes applying the polymeric build material composition to form a build material layer and based on a 3D object model, selectively applying a fusing agent onto at least a portion of the build material layer, thereby forming a patterned portion. The fusing agent used in the method includes the formulation described herein. In another example, the method further includes, based on the 3D object model, applying the detailing agent onto another portion of the build material layer.

In an example method, a layer of the build material composition is applied on a build area platform. It is to be understood that any of the polymeric build materials described herein may be used in the method as or in the build material composition. A printing system may be used to apply the build material composition. The printing system may include the build area platform, a build material supply containing the build material composition, and a build material distributor.

The build area platform receives the build material composition from the build material supply. The build area platform may be moved in various directions so that the build material composition may be delivered to the build area platform or to a previously formed layer. In an example, when the build material composition is to be delivered, the build area platform may be programmed to advance (e.g., downward or in the Z direction relative to the X-Y plane of the build area platform) enough so that the build material distributor can push the build material composition onto the build area platform to form a substantially uniform layer of the build material composition thereon. The build area platform may also be returned to its original position, for example, when a new part is to be built.

The build material supply may be a container, bed, or other surface that is to position the build material composition between the build material distributor and the build area platform. The build material supply may include heaters so that the build material composition is heated to a supply temperature ranging from about 25° C. to about 200° C. In these examples, the supply temperature may depend, in part, on the build material composition used and/or the 3D printer used. As such, the range provided is one example, and higher or lower temperatures may be used.

The build material distributor may be moved in various directions, over the build material supply and across the build area platform to spread the layer of the build material composition over the build area platform. The build material distributor may also be returned to a position adjacent to the build material supply following the spreading of the build material composition. The build material distributor may be a blade (e.g., a doctor blade), a roller, a combination of a roller and a blade, and/or any other device capable of spreading the build material composition over the build area platform. For instance, the build material distributor may be a counter-rotating roller. In some examples, the build material supply or a portion of the build material supply may translate along with the build material distributor such that build material composition is delivered continuously to the build area platform.

The build material supply may supply the build material composition into a position so that it is ready to be spread onto the build area platform. The build material distributor may spread the supplied build material composition onto the build area platform. The controller may process “control build material supply” data, and in response, control the build material supply to appropriately position the particles of the build material composition, and may process “control spreader” data, and in response, control the build material distributor to spread the build material composition over the build area platform to form the layer.

The build material layer has a substantially uniform thickness across the build area platform. In an example, the build material layer has a thickness ranging from about 50 μm to about 120 μm. In another example, the thickness of the build material layer ranges from about 30 μm to about 300 μm. It is to be understood that thinner or thicker layers may also be used. For example, the thickness of the build material layer may range from about 20 μm to about 500 μm. The layer thickness may be about 2× (i.e., 2 times) the average diameter of the polymeric material at a minimum for finer part definition. In some examples, the layer thickness may be about 1.2× the average diameter of the polymeric material in the build material composition.

After the build material composition has been applied, and prior to further processing, the build material layer may be exposed to heating. In an example, the heating temperature may be below the melting point or melting range of the polymeric material in the build material composition. As examples, the pre-heating temperature may range from about 5° C. to about 50° C. below the melting point or the lowest temperature of the melting range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition used. As such, the ranges provided are some examples, and higher or lower temperatures may be used.

Pre-heating the layer may be accomplished by using any suitable heat source that exposes all of the build material composition in the build material layer to the heat. Examples of the heat source include a thermal heat source (e.g., a heater integrated into the build area platform (which may include sidewalls)) or a radiation source. After the layer is formed, and in some instances is pre-heated, the fusing agent is selectively applied on at least some of the build material composition in the layer to form a patterned portion.

The amount of the fusing agent that is applied per unit of the build material composition in the patterned portion may be sufficient to absorb and convert enough energy so that the build material composition in the patterned portion will coalesce. The amount of the fusing agent that is applied per unit of the build material composition may depend, at least in part, on the dye loading in the fusing agent, and the polymeric material in the build material composition. In particular, the concentration of the dye or dyes in the fusing agent can be considered. This concentration can be used to determine how much fusing agent to apply to achieve a weight ratio of fusing agent to build material composition for acceptable layer-by-layer fusing. If applying the fusing agent to the build material composition at about a 1:9 weight ratio, then the dye to build material composition weight ratio (as applied) can be from about 1:900 to about 35:900. If more or less of the fusing agent is applied to the build material composition, then these ratios can be adjusted accordingly.

The fusing agent may be dispensed from an applicator. The applicator may include a thermal inkjet printhead, a piezoelectric printhead, a continuous inkjet printhead, etc. in fluid communication with a fluid reservoir/container, and the selective application of the fusing agent may be accomplished by thermal inkjet printing, piezo electric inkjet printing, continuous inkjet printing, etc. The controller may process data, and in response, control the applicator to deposit the fusing agent onto pre-determined portion(s) of the build material composition to generate the patterned portion.

In some examples, the method further comprises selectively applying, based on the 3D object model, the detailing agent onto another portion of the build material layer outside of the patterned portion. The detailing agent may be selectively applied to the portion(s) of the layer that are not patterned with the fusing agent, and thus that are not to become part of a final 3D object layer. Thermal energy generated during radiation exposure may propagate into the surrounding portion(s) that do not have the fusing agent applied thereto. The propagation of thermal energy may be inhibited and, in turn, the coalescence of the non-patterned build material portion(s) may be prevented when the detailing agent is applied to these other portion(s).

In some other examples, the detailing agent may also or alternatively be applied to the patterned portion or a portion of the patterned portion (i.e., with the fusing agent). The detailing agent may be applied to the patterned portion to provide a cooling effect so that the build material does not overheat and/or to lower the extent of fusing in the area patterned with both the fusing agent and the detailing agent. In these examples, the amount of the detailing agent that is applied should be low enough so that fusing is not completely inhibited. In other examples, the detailing agent and the fusing agent may intermingle at the edge(s) between the patterned portion and the other portion(s).

The detailing agent may be dispensed from an applicator. The applicator may include a thermal inkjet printhead, a piezoelectric printhead, a continuous inkjet printhead, etc. in fluid communication with a fluid reservoir/container, and the selective application of the detailing agent may be accomplished by thermal inkjet printing, piezo electric inkjet printing, continuous inkjet printing, etc. The controller may process data, and in response, control the applicator to deposit the detailing agent onto pre-determined portion(s) of the build material composition to generate the portion(s).

It is to be understood that the selective application of any of the fusing agent and/or the detailing agent may be accomplished in a single printing pass or in multiple printing passes. In some examples, the agent(s) is/are selectively applied in a single printing pass. In some other examples, the agent(s) is/are selectively applied in multiple printing passes. In one of these examples, the number of printing passes ranges from 2 to 4. The fusing agent and/or the detailing agent may be applied in multiple printing passes to increase the amount, which is applied to the build material composition, to avoid liquid splashing, to avoid displacement of the build material composition, etc.

After the fusing agent and/or detailing agent are selectively applied in the specific portion(s) of the layer, the entire layer of the build material composition is exposed to electromagnetic radiation in the form of visible light. The electromagnetic radiation is emitted from a visible light source. The radiation source may include visible light lamps, visible light emitting diodes, or another broad-spectrum light source emitting the suitable visible light wavelength(s). The length of time the electromagnetic radiation is applied for, or energy exposure time, may be dependent, for example, on: characteristics of the radiation source; characteristics of the build material composition; and/or characteristics of the fusing agent. In an example, a single point of the build material layer is exposed to electromagnetic radiation for a period of time ranging from 0.01 second to 1 second.

It is to be understood that the electromagnetic radiation exposure may be accomplished in a single radiation event or in multiple radiation events. The term “event,” as used herein, refers to one period of exposure of electromagnetic radiation from the radiation source. In an example, a radiation event may occur as a pass of a moveable radiation source over the build material layer (similar to a printing pass). In an example, the exposing of the build material composition is accomplished in multiple radiation events. In a specific example, the number of radiation events ranges from 1 to 8. In still another specific example, the exposure of the build material composition to electromagnetic radiation may be accomplished in 3 radiation events. The build material composition may be exposed to electromagnetic radiation in multiple radiation events to counteract a cooling effect that may be brought on by the amount of the 3D printing fusing agent, alone or in combination with the detailing agent that is applied to the build material layer. Additionally, the build material composition may be exposed to electromagnetic radiation in multiple radiation events to sufficiently elevate the temperature of the build material composition in the portion(s) without overheating the build material composition in the non-patterned portion(s).

The fusing agent enhances the absorption of the radiation, converts the absorbed radiation to thermal energy, and promotes the transfer of the thermal energy (heat) to the build material composition in contact therewith. In an example, the fusing agent sufficiently elevates the temperature of the build material composition in the portion to a temperature above the melting point or within the melting range of the polymeric material, allowing coalescing/fusing (e.g., thermal merging, melting, binding, etc.) of the build material composition to take place. The application of the electromagnetic radiation forms the 3D object layer.

In some examples, the electromagnetic radiation has a wavelength ranging from 380 nm to 700 nm. Radiation having wavelengths within the provided ranges may be substantially absorbed (e.g., 80% or more of the applied radiation is absorbed) by the fusing agent and may heat the build material composition in contact therewith. Further, the radiation may not be substantially absorbed (e.g., 25% or less of the applied radiation is absorbed) by the non-patterned build material composition in portion(s).

After the 3D object layer is formed, additional layer(s) may be formed thereon to create an example of the 3D object. To form the next layer, additional build material composition may be applied on the 3D object layer. The fusing agent is then selectively applied on at least a portion of the additional build material composition, according to the 3D object model. The detailing agent may be applied in any area of the additional build material composition where coalescence is not supposed to take place and/or where the extent of fusing is to be reduced. After the fusing agent and/or detailing agent is/are applied, the entire additional layer of the additional build material composition is exposed to electromagnetic radiation in the manner described herein. The application of additional build material composition, the selective application of the fusing agent, alone or in combination with the detailing agent, and the electromagnetic radiation exposure may be repeated for a predetermined number of cycles to form the final 3D object in accordance with the 3D object model. As such, some examples of the method include repeating the applying of the build material composition, the selectively applying of the fusing agent, and the exposing, to form a predetermined number of 3D object layers and a 3D printed object.

In the examples disclosed herein, a 3D object may be printed in any orientation. For example, the 3D object can be printed from bottom to top, top to bottom, on its side, at an angle, or any other orientation. The orientation of the 3D object can also be formed in any orientation relative to the layering of the build material composition. For example, the 3D object can be formed in an inverted orientation or on its side relative to the layering of the build material composition. The orientation of the build within each layer can be selected in advance or even by the user at the time of printing, for example.

Examples of the method described herein may be used to generate individual 3D object layers that make up a three-dimensional (3D) printed article/part. Even though the 3D printed article contains the dye or dyes, the amount of the dye(s) used leads to a 3D printed article exhibiting a base color (i.e., the color has an L* greater than 40). By “exhibits a color,” it is meant that the color of 3D printed object being referred to closely resembles the color of the dye included in the fusing agent.

### Post-Process Dyeing

Once the 3D printed object has been printed in accordance with the method described herein, the 3D printed object can be further colored using a post-process dyeing method or technique. Any suitable post-process dyeing method or technique can be used. As one example, the 3D printed object may be colored by direct or immersion dyeing. This technique involves preparing a dye solution by diluting a selected dye in water), where the amount of dye used depends on the hue and color intensity that is to be obtained. For instance, a ratio of water-to-dye in the dye solution is much higher when trying to achieve lighter colors, whereas the ratio of water-to-dye in the dye solution is much lower when trying to achieve darker colors.

Examples of dyes that may be used for post-process dyeing include RIT® dyes. Selection of the dye(s) for post-processing may be based, at least in part, on the base color of the 3D printed object and the predetermined color for the final object. In one example, a red dye, a pink dye, an orange dye, a blue dye, a green dye, or combinations thereof may be used during post-process dyeing of 3D printed objects having an orange base color. In yet another example, a green dye, blue dye, or purple dye may be used during post-process dyeing of 3D printed objects having a green base color. Generally, the color of the dye used in the post-printing dye process is similar to or darker than the base color. Multiple dyes may also be used in the post-printing dye process to achieve multi-colored parts.

The dye solution may be placed into a vat, a tank, or other suitable receptacle and the dyeing technique further involves submerging the 3D printed object into the dye solution. In an example, the dyeing solution is heated prior to submerging the 3D printed object. The entire 3D printed object is submerged into the dye solution. However, a portion of the 3D object could be submerged such that just the submerged portion of the 3D printed object gets colored. The submerged object/portion remains in the dye solution for a predetermined period of time (i.e., is soaked). The amount of time that the 3D printed object is soaked in the dye solution depends, at least in part, on the color and/or color intensity of the resultant-colored object.

After soaking, the colored 3D printed object is removed from the dye solution, rinsed with deionized water, and allowed to dry in either ambient conditions or in the presence of compressed air.

Other dyeing techniques that are used for fabric dyeing could also be used, but such techniques may have to be adjusted for coloring 3D printed parts. Examples of such techniques may include jig dyeing, reactive dyeing, jet dyeing, and resist dyeing to name a few. Dyeing techniques other than those specifically mentioned above, whether specific for 3D printed objects or for fabrics, are also contemplated as being suitable for the post-printing processing, as long they do not deleteriously affect the polymer 3D printed object.

### 3D Printed Object

A 3D printed object is formed by the 3D printing method described above, prior to exposure to the post-process dyeing. This 3D printed object includes coalesced polymeric build material and exhibits a base color due, at least in part, to the visible light absorbing dye(s) used in the fusing agent during 3D printing. As will be illustrated in the Examples section, it has been found that the base color of the 3D printed object can be readily dyed to a predetermined color, which is selected from a wide selection of colors. In an example, the 3D printed object, prior to post-process dyeing, exhibits a primary color or a secondary color, as the base color, having a lightness value L* that is greater than 40. If the base color of the 3D printed object had an L* of 40 or less, it is believed that the post-printing dyeing process would not achieve a predetermined color due to the darkness of the base color.

The 3D printed object includes a plurality of build material layers of coalesced polymeric build material. While most of the plasticizing solvent package is evaporated during printing, a residual amount of the plasticizing solvent package is likely to remain. In an example, less than 3 wt % of the plasticizing solvent package remains in the 3D printed object.

It is to be understood that other components of the build material composition (e.g., whitener, etc.) and components of the fusing agent that do not evaporate may also be present in the 3D printed object. The weight percentage of each component may depend on the amount used in the build material composition and/or the fusing agent, the dimensions of the 3D printed object, the amount of the fusing agent applied, the evaporation rate (if any) of the components, and other like conditions or parameters.

To further illustrate the present disclosure, example(s) are given herein. It is to be understood that these example(s) are provided for illustrative purposes and are not to be construed as limiting the scope of the present disclosure.

### EXAMPLES

A first sample fusing agent was prepared for production-scale Multi-Jet Fusion (MJF) 3D printers in order to obtain colored 3D printed objects. The formulation of the first fusing agent is set forth in Table 2 below, and the dye levels were adjusted to obtain a reddish orange colored fusing agent. The first fusing agent is an example of the present disclosure.

TABLE 2

| Fusing Agent | % active | wt % |
|---|---|---|
| 1-(2-hydroxyethyl-2-pyrrolidone) | 100 | 30-50 |
| Acid Yellow 23 | 10 | 1-3 |
| Acid Red 52 | 10 | 0.1-0.5 |
| Benzyl alcohol | 100 | 1-20 |
| TERGITOL 15-S-9 | 100 | 0.8 |
| DI H2O | 100 | Balance |

A second fusing agent was also prepared, which had the same formulation as the first fusing agent except that the two dyes (Acid Yellow 23 and Acid Red 52) were replaced with Acid Yellow 23 alone (i.e., no Acid Red 52). The second fusing agent is also an example of the present disclosure.

The build material composition included a thermoplastic polyamide elastomer.

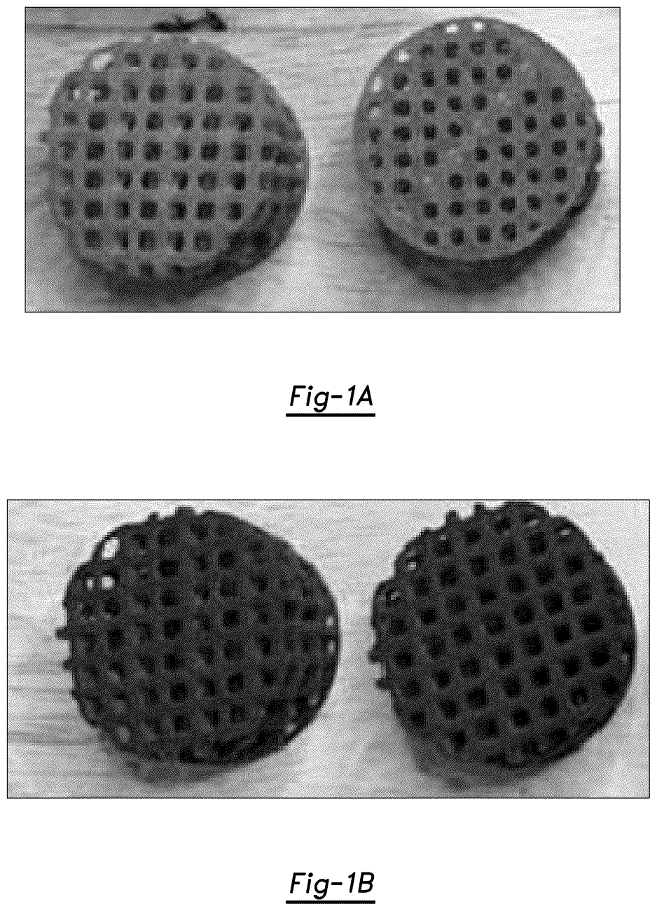

Two objects, both in the shape of a disc, were 3D printed, in a layer-by-layer fashion as described herein, using the build material composition and the first fusing agent. Both of the discs had a reddish color. A photograph of the two discs formed using the first fusing agent is shown in FIG. 1A.

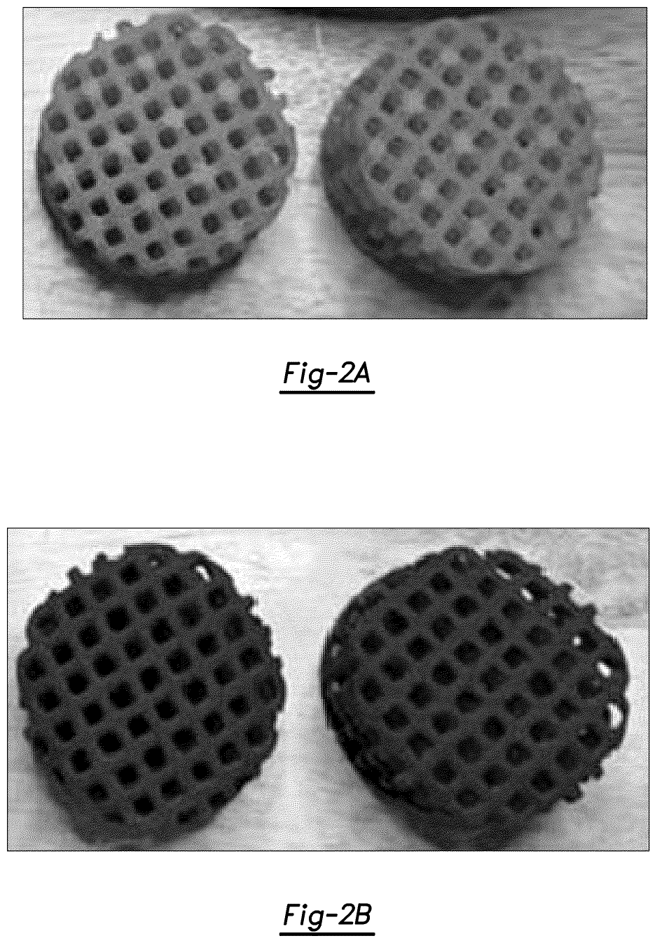

Two more objects, also in the shape of discs, were printed, in a layer-by-layer fashion as described herein, using the second fusing agent. Both of the discs had a yellow color. A photograph of the two discs formed using the second fusing agent is shown in FIG. 2A.

Next, all of the discs shown in FIGS. 1A and 2A were dyed with a blue dye packet from DyeMansion in a DyeMansion DM60 machine. After the dyeing process, the colored discs formed using the first fusing agent had a deep blue color, as shown in the photograph in FIG. 1B. In a similar fashion, the colored discs formed using the second fusing agent also a deep blue color after the dyeing process. The dyed colored discs formed using the second fusing agent are shown in the photograph in FIG. 2B. These results demonstrate that printing with the fusing agents of the present disclosure (which included the visible light absorbing dye(s)) produces 3D printed objects/parts having a base color with suitable dyeing capability.

A third fusing agent was prepared for production-scale MJF 3D printers in order to obtain colored, 3D printed purses. The formulation of the third fusing agent for this example is set forth in Table 2, and the dye levels were adjusted to obtain a light orange colored fusing agent.

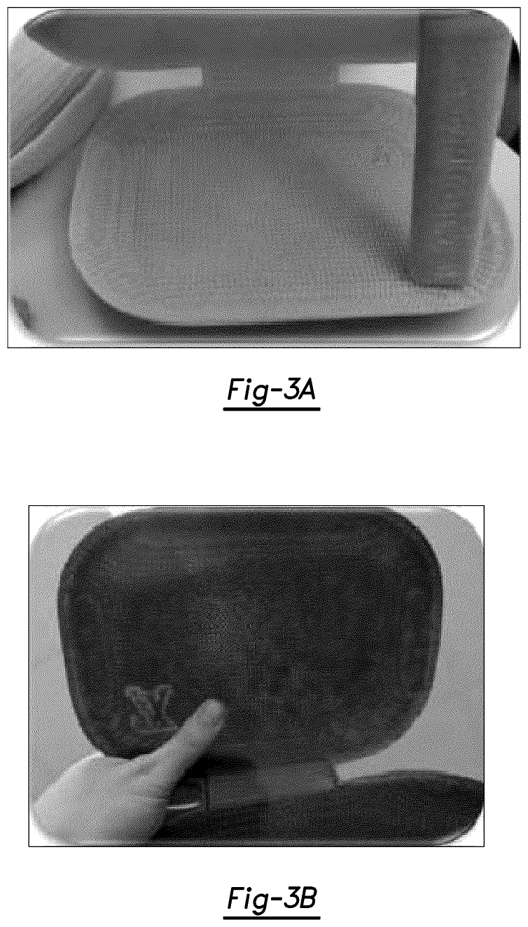

Purses were printed using a production-scale Multi-Jet Fusion (MJF) 3D printer and a thermoplastic polyamide elastomer as the build material. A photograph of one of the purse samples is shown in FIG. 3A and the purse sample had a light orange color.

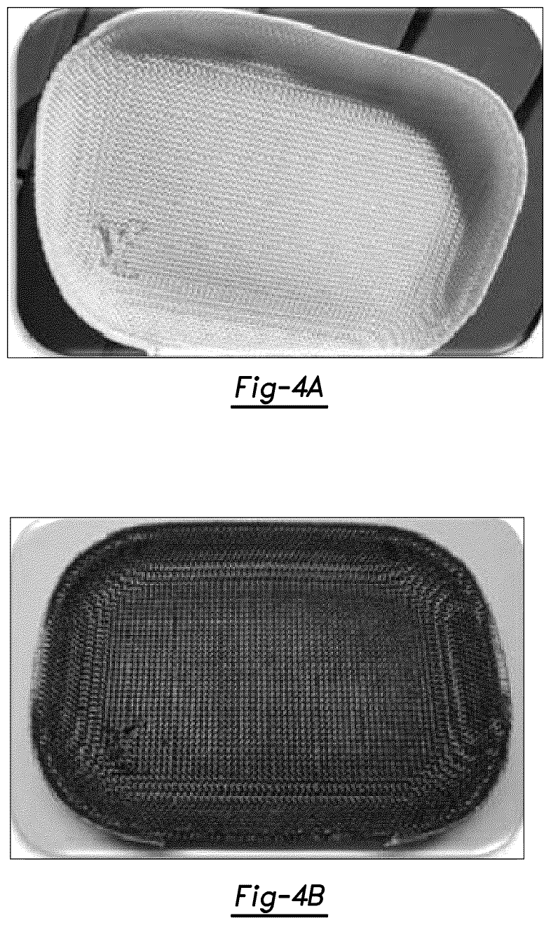

A comparative purse was printed using a comparative fusing agent formulation. This comparative fusing agent had the same formulation as set forth in Table 2, except that the dyes were replaced with avobenzone as a colorless ultraviolet light absorbing energy absorber. A photograph of the comparative purse, which had an off-white color, is shown in the photograph in FIG. 4A.

Next, both of the 3D printed purses were dyed by an external vendor. The dying processes changed the color of the sample and comparative purses to shades of red. The purse formed using the third fusing agent is shown having a bright red color in the photograph in FIG. 3B. Similarly, the purse formed using the comparative fusing agent is also shown having a bright red color in the photograph in FIG. 4B. These results demonstrate that printing with the third fusing agent (which included the visible light absorbing dyes) produces 3D printed objects/parts having a light base color that can be dyed to achieve the color quality and fidelity of an off-white 3D object dyed in the same manner.

### Additional Notes

It is to be understood that the ranges provided herein include the stated range and any value or sub-range within the stated range. For example, from about 0.01 wt % active to about 0.35 wt % active should be interpreted to include not only the explicitly recited limits of from about 0.01 wt % active to about 0.35 wt % active, but also to include individual values, such as about 0.05 wt % active, about 0.29 wt % active, about 0.14 wt % active, about 0.08 wt % active, etc., and sub-ranges, such as from about 0.1 wt % active to about 0.25 wt % active, from about 0.2 wt % active to about 0.3 wt % active, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional printing kit, comprising:
a fusing agent including:
a plasticizing solvent package consisting of:
i) from about 40 wt % active to about 60 wt % active of propylene glycol; or
ii) from about 1 wt % active to about 20 wt % active of an aromatic alcohol and from about 30 wt % active to about 50 wt % active of a plasticizing solvent that increases water solubility of the aromatic alcohol; or
iii) from about 10 wt % active to about 30 wt % active of propylene glycol, from about 5 wt % active to about 20 wt % active of an aromatic alcohol, and from about 20 wt % active to about 50 wt % active of a plasticizing solvent that increases water solubility of the aromatic alcohol, with the caveat that a total solvent amount is 75 wt % active or less;
from about 0.01 wt % active to about 0.35 wt % active of a visible light absorbing dye selected from the group consisting of a yellow dye, a red dye, a blue dye, an orange dye, a green dye, a purple dye, and combinations thereof; and
a balance of water,
wherein the wt % of each component of the fusing agent is based on a total weight of the fusing agent; and
a polymeric build material composition.

2. The three-dimensional printing kit as defined in claim 1, wherein:
the solvent package consists of the aromatic alcohol and the plasticizing solvent;
the aromatic alcohol is benzyl alcohol; and
the plasticizing solvent is selected from the group consisting of 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, poly(ethylene glycol) 300, and combinations thereof.

3. The three-dimensional printing kit as defined in claim 1, wherein:
the solvent package consists of propylene glycol, the aromatic alcohol, and the plasticizing solvent;
the aromatic alcohol is benzyl alcohol; and
the plasticizing solvent is selected from the group consisting of 2-pyrrolidone, 1-(2-hydroxyethyl)-2-pyrrolidone (HE2P), glycerol, isopropylidene glycerol (IPG), 2-methyl-1,3-propanediol, 1,2-butane diol, diethylene glycol, triethylene glycol, tetraethylene glycol, dipropylene glycol, diethylene glycol butyl ether, poly(ethylene glycol) 300, and combinations thereof.

4. The three-dimensional printing kit as defined in claim 1, wherein:
the visible light absorbing dye includes a combination of the yellow dye and the red dye;
the yellow dye is present in an amount ranging from about 0.1 wt % active and about 0.3 wt % active, based on the total weight of the fusing agent; and
the red dye is present in an amount ranging from about 0.01 wt % active and about 0.05 wt % active, based on the total weight of the fusing agent.

5. The three-dimensional printing kit as defined in claim 4, wherein:
the yellow dye is selected from the group consisting of Acid Yellow 23, Acid Yellow 17, and Acid Yellow 73; and
the red dye is selected from the group consisting of Acid Red 52, Acid Red 88, and Acid Red 18.

6. The three-dimensional printing kit as defined in claim 4, further comprising a second dye that is separate from the fusing agent, wherein the second dye is selected from the group consisting of a red dye, a pink dye, an orange dye, a blue dye, a green dye, and combinations thereof.

7. The three-dimensional printing kit as defined in claim 1, wherein:
the visible light absorbing dye includes a combination of the red dye and the orange dye;
the red dye is present in an amount ranging from about 0.1 wt % active and about 0.3 wt % active, based on the total weight of the fusing agent; and
the blue dye is present in an amount ranging from about 0.01 wt % active and about 0.05 wt % active, based on the total weight of the fusing agent.

8. The three-dimensional printing kit as defined in claim 7, wherein:
the red dye is selected from the group consisting of Acid Red 52, Acid Red 88, and Acid Red 18; and
the blue dye is an Acid Blue dye.

9. The three-dimensional printing kit as defined in claim 7, further comprising a second dye that is separate from the fusing agent, wherein the second dye is selected from the group consisting of a red dye, a pink dye, an orange dye, a blue dye, a green dye, and combinations thereof.

10. The three-dimensional printing kit as defined in claim 1, wherein:
the visible light absorbing dye includes a combination of the yellow dye and the blue dye;
the yellow dye is present in an amount ranging from about 0.1 wt % active and about 0.3 wt % active; and
the blue dye is present in an amount ranging from about 0.01 wt % active and about 0.05 wt % active.

11. The three-dimensional printing kit as defined in claim 10, wherein:
the yellow dye is selected from the group consisting of Acid Yellow 23, Acid Yellow 17, and Acid Yellow 73; and
the blue dye is an Acid Blue dye.

12. The three-dimensional printing kit as defined in claim 10, further comprising a second dye that is separate from the fusing agent, wherein the second dye is a blue dye, a green dye, or a purple dye.

13. A method for using the three-dimensional printing kit of claim 1,
comprising:
generating a 3D printed part having an L* greater than 40 and containing multiple fused layers, each of the multiple fused layers being formed by:
forming a layer of the polymeric build material composition;
based on a 3D object model, selectively applying the fusing agent to the layer; and
exposing the layer to light that the dye is capable of absorbing.

14. The method as defined in claim 13, further comprising dyeing the 3D printed part with a second dye.

15. A 3D printed part, comprising:
coalesced polymeric build material; and
a residual amount of a plasticizing solvent package present in the coalesced polymeric build material;
wherein the 3D printed part exhibits a primary color or a secondary color having an L* greater than 40.
